(19) United States
(12) Patent Application Publication
(10) Pub. No.: US 2021/0383182 A1
(43) Pub. Date: Dec. 9, 2021

(54) ELECTRONIC HEAT TRANSFER LABEL AND PREPARATION METHOD THEREOF

(71) Applicant: Maxim Smart Manufacturing Co., Ltd., Zhejiang Province (CN)

(72) Inventor: SHEN-TAO CHAI, Zhejiang Province (CN)

(73) Assignee: Maxim Smart Manufacturing Co., Ltd., Zhejiang Province (CN)

(21) Appl. No.: 16/936,441

(22) Filed: Jul. 23, 2020

(30) Foreign Application Priority Data
Jun. 6, 2020 (CN) 202010509689.6

(51) Int. Cl. G06K 19/07; G06K 19/077; B32B 7/12; B32B 27/36; B32B 38/00; B32B 27/08; B32B 27/12; B32B 37/12; D06H 1/04; B41J 3/407

(52) U.S. Cl. CPC G06K 19/0723; B32B 2255/10; B32B 7/12; B32B 27/36; B32B 38/145; B32B 27/08; B32B 27/12; B32B 37/1207; D06H 1/046; B41J 3/4075; B32B 2519/02; B32B 2255/28; B32B 2307/212; B32B 2037/1215; G06K 19/0776

(57) ABSTRACT

An electronic heat transfer label includes a substrate. A pattern layer is printed on the substrate, and an adhesive is printed on the pattern layer to form a first adhesive layer. A chip is attached onto the first adhesive layer, and an adhesive is printed on the chip to form a second adhesive layer. The second adhesive layer covers the chip, and a hot-melt layer is arranged on the second adhesive layer. A method for preparing the electronic heat transfer label includes: S1: printing an ink on a substrate and drying the ink to form a pattern layer; S2: printing an adhesive on the pattern layer and drying to form a first adhesive layer; S3: attaching a chip onto the first adhesive layer; S4: printing an adhesive onto the first adhesive layer and the chip, and drying to form a second adhesive layer.

### CROSS REFERENCE TO THE RELATED APPLICATIONS

This application is based upon and claims priority to Chinese Patent Application No. 202010509689.6, filed on Jun. 6, 2020, the entire contents of which are incorporated herein by reference.

### TECHNICAL FIELD

The present invention belongs to the field of electronic labels, and more particularly, relates to an electronic heat transfer label and a preparation method thereof.

### BACKGROUND

Chinese patent No. 2013100580182 discloses a manufacturing method for an electronic ultrahigh-frequency (UHF) woven label. The manufacturing method includes the steps of silk-screening (i) a release agent, (ii) a first transparent ink layer, (iii) ink and (iv) an antenna, encapsulating a UHF chip and silk-screening a second transparent ink layer, silk-screening an adhesive, cutting, hot stamping, removing a printing sheet and other steps. The patented method further discloses an electronic UHF woven label manufactured according to the method. The manufacturing method for an electronic UHF woven label uses a woven label as the substrate, whereby a single inlay is directly hot stamped on the woven label. This manufacturing method does not need additional wrapping and other processes compared with existing manufacturing methods for the electronic UHF woven label, thus simplifying the manufacturing process.

Although the foregoing patent application discloses an electronic woven label, when made into a finished fabric product or garment, the label, if placed outside, is not aesthetically appealing. Besides, the inlay is hot stamped on the woven label rather than on the garment, and the woven label is not provided with a hot-melt layer and thus cannot be securely bonded onto the garment. Moreover, after the label made by this method is repeatedly washed in water, the chip is prone to come loose and even be damaged.

Chinese patent No. 2014202398610 discloses a radio frequency identification (RFID) label printed on a garment, including at least two layers of hot-melt adhesive adhered to the garment. The outer layer of the hot-melt adhesive is provided with 4-6 layers of water-based elastic coating ink, and a flexible RFID antenna is printed between the water-based elastic coating ink. A chip is embedded in a coil of the flexible RFID antenna. The outer layer of the water-based elastic coating ink is provided with 2-4 layers of ink printed patterns, and the outermost layer of the patterns is provided with a polyethylene terephthalate (PET) release film.

Although the RFID label combines the patterns with RFID, the chip is embedded between the water-based elastic coating ink. After the label is washed many times, the ink layers and the chip layer are prone to delamination and come loose, and even the chip is exposed and damaged, which affects data collection and reading. Additionally, since the label is not provided with a shielding layer, it is easy to observe the chip placed in the label from the reverse side of the garment.

### SUMMARY

In view of the shortcomings in the prior art, the present invention provides an electronic heat transfer label. A chip is embedded in the heat transfer label to facilitate data storage, reading and anti-counterfeiting, and effectively protect the electronic label, so that the chip can still be used normally after the electronic label is repeatedly washed in water.

To achieve the foregoing objective, the present invention provides the following technical solutions. An electronic heat transfer label includes a substrate. Ink is printed on the substrate to form a pattern layer, and an adhesive is printed on the pattern layer to form a first adhesive layer. A chip is attached onto the first adhesive layer, and an adhesive is printed on the chip to form a second adhesive layer. The second adhesive layer covers the chip, and a hot-melt layer is arranged on the second adhesive layer.

The adhesive is preferably glue.

The pattern layer is a transparent, solid-colored or multi-colored image, or an image containing a Quick Response (QR) code, a bar code, a digital watermark or other scannable marks.

Further, the hot-melt layer includes at least one layer of glue; or the hot-melt layer includes at least one layer of transparent ink and hot-melt powder adhered onto the transparent ink.

Further, the one layer of glue has a thickness of 0.01-0.04 mm after being dried.

Further, colored ink is printed on the second adhesive layer to form a shielding layer.

Further, an anti-sublimation ink is printed on the second adhesive layer to form an anti-sublimation layer.

Further, a white background layer is arranged between the pattern layer and the first adhesive layer.

Further, the pattern layer includes at least three layers of ink in total.

Further, the pattern layer and the white background layer include at least three layers of ink in total.

Further, the chip is an RFID chip or a near-field communication (NFC) chip.

A mobile terminal triggers the RFID chip or the NFC chip through wireless induction. An application (such as an application module with a sensing function) configured to trigger the RFID chip or the NFC chip is built in the mobile terminal. When the electronic heat transfer label is sensed by the mobile terminal, an information code stored in the RFID/NFC chip can be read. Alternatively, after the mobile terminal further senses the RFID/NFC chip, the mobile terminal is triggered to be connected to the corresponding product information database, so that the information code stored in the RFID/NFC chip can correspond to/be associated with the information in the product database.

Further, the mobile terminal reads information stored in the RFID chip or NFC chip, compares the information with relevant information in the information database of the product (garments or articles) corresponding to the electronic heat transfer label, and feeds back the authenticity of the product corresponding to the electronic heat transfer label according to the comparison result.

Specifically, for the electronic heat transfer label with a built-in RFID chip, after a Tag Identification (TID) code and an Electronic Product Code (EPC) code in the RFID chip are read via the mobile terminal, the TID code and the EPC code are compared with a TID code and an EPC code pre-stored in the product information database. If the TID code and EPC code can correspond to the real TID code and EPC code in the database, the product corresponding to the label is fed back as authentic. If the TID code and the EPC code cannot correspond to the TID code and the EPC code in the database, the product corresponding to the label is fed back as counterfeit.

For the label with a built-in NFC chip, a Unique Identification (UID) code in the NFC chip is read via the mobile terminal, and the UID code is compared with the UID code pre-stored in the database. If the UID code can correspond to the real UID code in the database, the product corresponding to the label is fed back as authentic; and if the UID code cannot correspond to the UID code in a label database, the product corresponding to the label is fed back as counterfeit.

Further, the chip is preferably an NFC chip. Ordinary consumers can read the information via a mobile phone with an NFC sensing function and a built-in related application (app), and further the read information is compared with the information in the information database of the product corresponding to the electronic heat transfer label to feed back the authenticity of the product.

The electronic heat transfer label is always attached to a product and thus is more reliable and practical for users to read information and perform anti-counterfeiting identification compared with an ordinary external electronic label.

A method for preparing an electronic heat transfer label includes the following steps:

S1: printing a colored ink on a substrate and drying to form a pattern layer;

S2: printing at least one layer of adhesive on the pattern layer and drying to form a first adhesive layer;

S3: attaching a chip onto the first adhesive layer;

S4: printing at least one layer of adhesive onto the first adhesive layer and the chip, and drying to form a second adhesive layer; and

S5: printing at least one layer of glue on the second adhesive layer and drying to form a hot-melt layer; or printing a transparent ink on the second adhesive layer, then spraying hot-melt powder on the surface of the wet transparent ink, and drying to form a hot-melt layer.

Further, after step S4 and before step S5, at least one layer of colored ink is printed on the second adhesive layer and dried to form a shielding layer to protect the chip from exposure.

Further, after step S4 and before step S5, an anti-sublimation ink is printed on the second adhesive layer and dried to form an anti-sublimation layer.

Further, an anti-sublimation ink is printed on the shielding layer and dried to form an anti-sublimation layer.

Further, after the ink is printed to form the pattern layer in step S1, white ink is printed on the pattern layer and dried to form a white background layer.

In step S1, after the ink is printed by a digital printer to form the pattern layer, a transparent ink is printed on the pattern layer by a screen printer and dried.

In the foregoing step, the drying can be performed through a drying tunnel.

Compared with the prior art, the present invention has the following advantages:

1. The chip (RFID chip or NFC chip) is embedded into the electronic heat transfer label, and securely wrapped and protected by the first adhesive layer and the second adhesive layer. In this way, the pattern layer is not easily damaged by the chip, and delamination between the various ink layers of the pattern layer and between the pattern layer and other layers is also avoided.

2. Multi-layer ink and adhesive are employed to enhance the elasticity and tensile properties of the whole label.

3. After being washed with water, the whole label remains intact and the chip can be read and used normally.

4. The shielding layer is utilized to better hide the chip in the label. This not only makes the label more aesthetically appealing but also prevents others from knowing that there is a chip inside and making fakes.

### BRIEF DESCRIPTION OF THE DRAWINGS

FIG. 1 is a structural schematic diagram of the electronic heat transfer label according to Embodiment 1 of the present invention;

FIG. 2 is a structural schematic diagram of the electronic heat transfer label according to Embodiment 2 of the present invention;

FIG. 3 is a structural schematic diagram of the electronic heat transfer label according to Embodiment 3 of the present invention; and

FIG. 4 is a structural schematic diagram of the electronic heat transfer label according to Embodiment 4 of the present invention.

Reference numerals in the figures: 1, substrate; 2, pattern layer; 3, white background layer; 4, first adhesive layer; 5, second adhesive layer; 6, chip; 7, hot-melt layer; 8, shielding layer; 9, anti-sublimation layer.

### DETAILED DESCRIPTION

In the description of the present invention, it should be noted that the orientation or positional relationships indicated by nouns of locality such as the terminologies “center”, “horizontal direction (X)”, “longitudinal direction (Y)”, “vertical direction (Z)”, “length”, “width”, “thickness”, “upper”, “lower”, “front”, “rear”, “left”, “right”, “vertical”, “horizontal”, “top”, “bottom”, “inside”, “outside”, “clockwise” and “counterclockwise” are based on orientation or positional relationships shown in the drawings, which are only for the convenience of describing the present invention and simplifying the description, rather than indicating or implying that the referred device or element must have a specific orientation and be constructed and operated in a specific orientation. Therefore, it cannot be construed as a limitation to the specific scope of protection of the present invention.

Moreover, the terminologies “first” and “second” are used to facilitate description and cannot be construed as indicating or implying relative importance or implicitly indicating the number of technical features. Therefore, the feature defined by “first” and “second” may explicitly or implicitly include one or more of the features. In the description of the present invention, “a plurality of” and “several” mean two or more, unless otherwise specifically defined.

### Embodiment 1

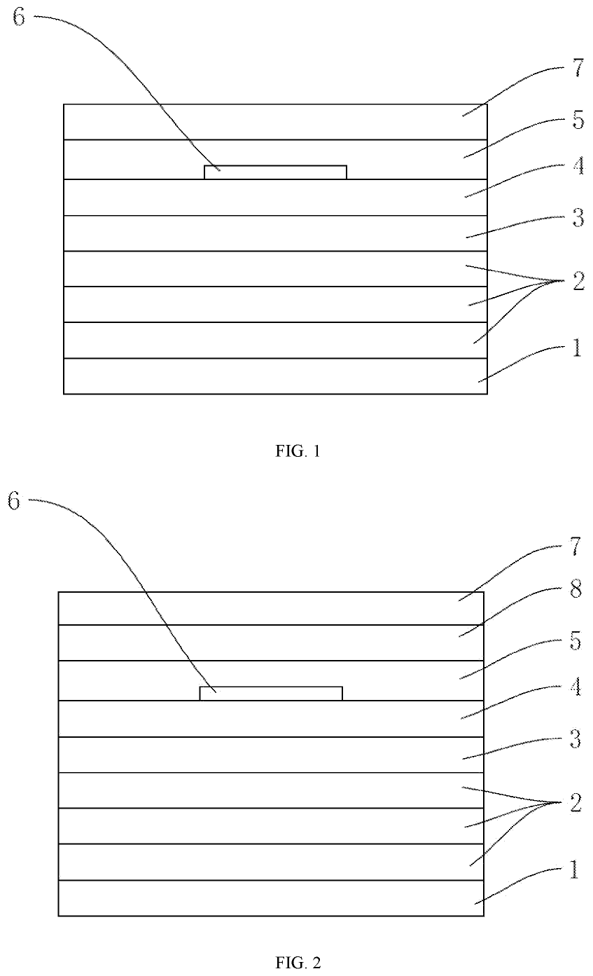

As shown in FIG. 1, an electronic heat transfer label includes the substrate 1. Ink is printed on the substrate 1 to form the pattern layer 2, and an adhesive is printed on the pattern layer 2 to form the first adhesive layer 4. The chip 6 is attached onto the first adhesive layer 4, and an adhesive is printed on the chip 6 to form the second adhesive layer 5. The second adhesive layer 5 covers the chip 6, and the hot-melt layer 7 is arranged on the second adhesive layer 5.

In the present embodiment, the substrate 1 may be made of PET, paper or other materials, wherein the adhesive is glue. Hereinafter, the first adhesive layer is referred to as a first glue layer, and the second adhesive layer is referred to as a second glue layer.

The hot-melt layer 7 in the present embodiment can be formed in either of the following alternatives. Alternative 1: liquid glue is printed on the second glue layer 5 to form the hot-melt layer 7. Alternative 2: A transparent ink is printed on the second glue layer 5, and when the transparent ink is wet, the hot-melt powder is sprayed on the surface of the transparent ink and drying to form the hot-melt layer 7, wherein the transparent ink is configured to provide a liquid environment for the hot-melt powder to adhere the hot-melt powder. The transparent ink is also called transparent oil in the industry.

In use, the electronic heat transfer label is transferred to a carrier such as fabric by a heat transfer technology, and the hot-melt layer 7 is in direct contact with the fabric. One side of the pattern layer 2 faces outward. In other words, after the heat transfer label is transferred to the fabric, the pattern layer 2 can be directly seen as the front side, the hot-melt layer 7 is on the back side, namely, the back side faces the fabric, while the front side faces outward. The chip 6 is covered by the ink of the pattern layer 2 and the first glue layer 4, so that the chip 6 is difficult to penetrate the pattern layer 2. And the glue layer 5 also wraps the chip 6, which all provide protection to the chip 6 and thus the chip 6 can still be read and used normally without being affected when washed with water.

In the present embodiment, the white background layer 3 is preferably arranged between the pattern layer 2 and the first glue layer 4. The white background layer 3 is printed with white ink and thus has good opacity and normally does not affect the pattern display, so that the pattern can be successfully displayed when the electronic label is viewed from the front, without being affected by the chip 6 and fabric behind the label. The ink of the white background layer 3 is preferably a white ink, a mixture of the white ink and a colored ink of the pattern layer 2, or other colored ink, which can achieve the effect to avoid affecting the display of the pattern layer 2 and provide further protection to the chip to make it impossible to be viewed from the front side.

In the present embodiment, preferably, the pattern layer 2 is provided with at least three layers of ink, the three layers of ink are printed by a screen printer or other printers. Generally, the number of colors of the pattern layer 2 to be printed is directly proportional to the number of printing times needed. When the number of layers is increased, the elasticity of the overall ink is improved, the tensile property of the label is also enhanced, and the pattern layer 2 is not easily damaged by the chip 6. The ink printed by the screen printer is preferably environmentally friendly water-based ink.

### Preparation Method of Embodiment 1

A method for preparing an electronic heat transfer label includes the following steps:

S1: The ink is printed on the substrate 1 and dried to form the pattern layer 2.

In the present embodiment, the substrate 1 made of PET is taken as an example. The PET is placed on a screen printer. Ink is successively printed on the PET according to the pattern to be printed. If it is necessary to print ink for three times to form the pattern layer 2, ink printed for the first time is printed on the surface of the PET, and then dried to form the first layer of ink of the pattern layer 2. Ink is printed for the second time, and in this case, the ink printed for the second time is printed on the first layer of ink and then dried to form the second layer of ink. Finally, ink printed for the third time is printed on the second layer of ink and dried to form a third layer of ink. The three layers of ink jointly form the pattern layer 2 to be printed. Optionally, if it is necessary to print the pattern layer 2 with more layers of ink, the method thereof is the same as the above. After each printing of ink, the ink needs to be dried in a drying tunnel or other drying equipment before the ink is printed for the next time. If the ink cannot be completely dried, which may cause delamination between the ink layers of the pattern layer 2.

The ink printed to form the pattern layer 2 preferably employs environmentally friendly water-based ink.

S2: The liquid glue is printed at least once on the dried pattern layer 2 by a silk-screening technology and dried to form the first glue layer 4. When multiple layers of liquid glue are printed, after the liquid glue is printed each time or each layer of liquid glue is printed, the liquid glue needs to be dried in a drying tunnel before being printed for the next time.

S3: The chip 6 is attached onto the dried first glue layer 4. Preferably, the chip 6 has a thickness of less than 0.1 mm. The plane size of the chip 6 is smaller than the area of the first glue layer 4. Preferably, the finished chip 6 is embedded between two layers of a carrier, e.g., polyester (PET) film. One layer of the carrier can be peeled off manually or by a labeling machine, and the chip 6, including the other layer of substrate 1, is attached onto the first glue layer 4. More preferably, the overall thickness of the chip 6 including one layer of the carrier bearing the chip 6 is less than 0.1 mm.

S4: Liquid glue is printed at least once by a silk-screening technology and dried so that the liquid glue is simultaneously printed on the first glue layer 4 and the chip 6 to form the second glue layer 5. Specifically, for the semi-finished product obtained in step S3, liquid glue is printed on the surface of the chip 6 by a screen printer, and the liquid glue is also printed on the surface of the first glue layer 4 in the uncovered area of the chip 6, so that the chip 6 is completely wrapped by the first glue layer 4 and the second glue layer 5, with no part of the chip being exposed to the ambient. The second glue layer 5 and the first glue layer 4 are both formed by drying and solidifying the liquid glue, and thus are securely bonded and difficult to separate. In the present embodiment, when the second glue layer 5 has multiple layers, the previous layer of liquid glue of the second glue layer 5 needs to be completely dried through a drying tunnel before each layer of the second glue layer 5 is printed and formed.

S5: The liquid glue is printed at least once on the second glue layer 5 by a silk-screening technology and dried to form the hot-melt layer 7. Alternatively, the transparent ink is printed on the second glue layer 5 by a silk-screening technology, then the hot-melt powder is sprayed on the surface of the wet transparent ink, and the wet transparent ink is dried to form the hot-melt layer 7.

In the present embodiment, the thickness of each layer of glue is preferably 0.01-0.04 mm.

In step S5 of the present embodiment, the hot-melt layer 7 can be formed in the foregoing two alternatives. For the first, the hot-melt layer 7 is formed by drying liquid glue without the use of hot-melt powder, which has a simple preparation process is; and all layers of the electronic label are bonded with liquid glue, which increases the layer-to-layer bonding. For the second, the transparent ink is printed, and then dried after the hot-melt powder is sprayed. The transparent ink has good elasticity and thus can improve the elasticity of the whole label while exhibiting optimal tensile properties.

In the present embodiment, the tunnel drying is preferably performed at a high temperature of 85-110° C. for a short time.

In the present embodiment, in step S1, a digital printer with built-in electronic ink can also be used. The electronic ink is printed on the substrate 1 to form the pattern layer 2. After printing, at least one layer of transparent ink is printed on the surface of the pattern layer 2 by a screen printer to enhance the ink elasticity of the pattern layer 2 without affecting the color display of the pattern layer 2 printed by the digital printer. Step S2 is performed after tunnel drying.

In the present embodiment, in order to add the white background layer 3, after step S1, that is, before step S2, the white ink is printed on the surface of the pattern layer 2 by a silk-screening technology and dried to form the white background layer 3, and then the liquid glue in step S2 is printed on the white background layer 3 to form the first glue layer 4.

### Embodiment 2

As shown in FIG. 2, the present embodiment is different from Embodiment 1 in that the colored ink is printed on the second glue layer 5 to form the shielding layer 8. Namely, the shielding layer 8 is arranged between the hot-melt layer 7 and the second glue layer 5, and other technical features are the same as those of Embodiment 1.

Specifically, the shielding layer 8 is printed on the second glue layer 5. Then, when the electronic heat transfer label is transferred to the fabric and viewed from the opposite side of the fabric (the back side of the chip 6), the chip 6 is covered by the shielding layer 8 and is thus hidden, and the shielding layer 8 cooperates with the white background layer 3 of Embodiment 1, so that whether viewed from the front side of the label or the opposite side of the fabric, it is impossible to detect the chip 6 inside. Additionally, the chip 6 has a thin profile making it difficult to observe from the side.

The preparation method of Embodiment 2 includes the following steps:

S1: The ink is printed on the substrate 1 and dried to form the pattern layer 2.

S2: The liquid glue is printed at least once on the pattern layer 2 by a silk-screening technology and dried to form the first glue layer 4.

S3: The chip 6 is attached onto the first glue layer 4 through a labeling machine.

S4: Liquid glue is printed at least once by the silk-screening technology and dried so that the liquid glue is simultaneously printed on the first glue layer 4 and the chip 6 to form the second glue layer 5.

S41: At least one layer of colored ink is printed on the second glue layer 5 by the silk-screening technology and dried to form the shielding layer 8 to protect the chip 6 from exposure. The ink herein is black or in other colors, and the color of the ink is selected according to the color of the pattern layer 2 and the color of the fabric, so that the chip 6 can be covered from the back side of the chip 6 without affecting the color display and aesthetics of the pattern layer 2.

S5: The liquid glue is printed at least once on the shielding layer 8 by the silk-screening technology and dried to form the hot-melt layer 7.

Other technical features are the same as those of Embodiment 1.

### Embodiment 3

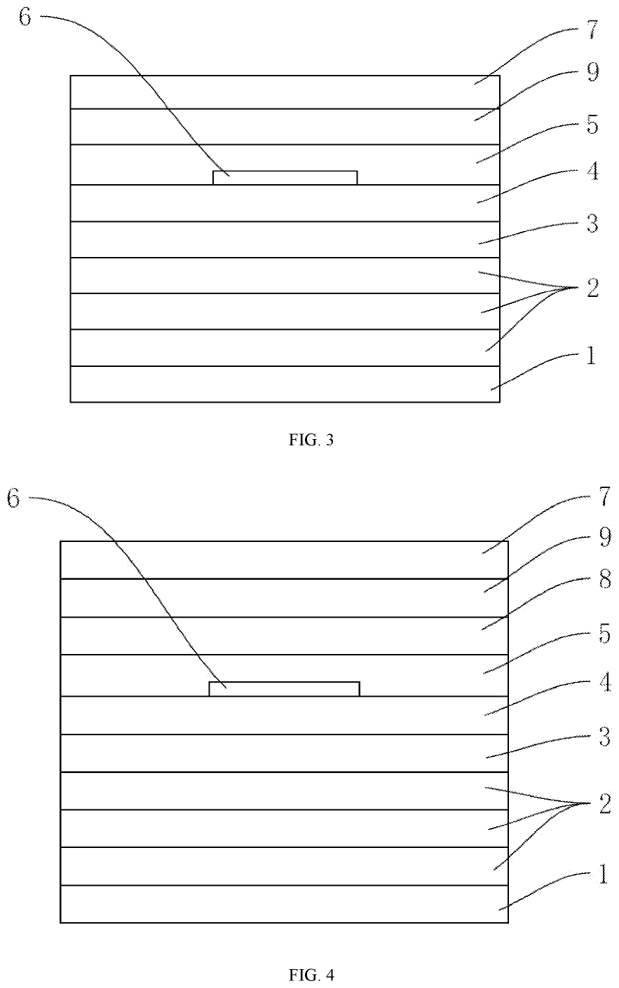

As shown in FIG. 3, the present embodiment is different from Embodiment 1 in that anti-sublimation ink is printed on the second glue layer 5 to form the anti-sublimation layer 9. Namely, the anti-sublimation layer 9 is located between the second glue layer 5 and the hot-melt layer 7. In use, the electronic heat transfer label is transferred to the fabric, and the anti-sublimation layer 9 can prevent the color on the fabric from sublimating to the electronic label to avoid dyeing the electronic label, so that the correct content of the pattern layer 2 can always be clearly displayed.

The preparation method of Embodiment 3 includes the following steps:

S1: The ink is printed on the substrate 1 and dried to form the pattern layer 2.

S2: The liquid glue is printed at least once on the pattern layer 2 by a silk-screening technology and dried to form the first glue layer 4.

S3: The chip 6 is attached onto the first glue layer 4 through a labeling machine.

S4: Liquid glue is printed at least once by the silk-screening technology and dried so that the liquid glue is simultaneously printed on the first glue layer 4 and the chip 6 to form the second glue layer 5.

S41: The anti-sublimation ink is printed on the second glue layer 5 by the silk-screening technology and dried to form the anti-sublimation layer 9.

S5: The liquid glue is printed at least once on the anti-sublimation layer 9 by the silk-screening technology and dried to form the hot-melt layer 7. Alternatively, the transparent ink is printed on the anti-sublimation layer 9 by the silk-screening technology, then hot-melt powder is sprayed on the surface of the wet transparent ink, and the wet transparent ink is dried to form the hot-melt layer 7.

Other technical features are the same as those of Embodiment 1.

### Embodiment 4

As shown in FIG. 4, the present embodiment is different from Embodiment 1 in that shielding ink is printed on the second glue layer 5 to form the shielding layer 8, and anti-sublimation ink is printed on the shielding layer 8 to form the anti-sublimation layer 9. In this case, the shielding layer 8 is configured to shield the back side of the chip 6 to hide the chip 6. The anti-sublimation layer 9 can prevent the color on the fabric from sublimating to the electronic label especially to the pattern layer 2.

The preparation method of Embodiment 4 includes the following steps:

S1: The ink is printed on the substrate 1 and dried to form the pattern layer 2.

S2: The liquid glue is printed at least once on the pattern layer 2 by a silk-screening technology and dried to form the first glue layer 4.

S3: The chip 6 is attached onto the first glue layer 4 through a labeling machine.

S4: Liquid glue is printed at least once by the silk-screening technology and dried so that the liquid glue is simultaneously printed on the first glue layer 4 and the chip 6 to form the second glue layer 5.

S41: A layer of colored ink is printed on the dried second glue layer 5 by the silk-screening technology and dried to form the shielding layer 8.

S42: The anti-sublimation ink is printed on the shielding layer 8 by the silk-screening technology and dried to form the anti-sublimation layer 9.

S5: The liquid glue is printed at least once on the anti-sublimation layer 9 by the silk-screening technology and dried to form the hot-melt layer 7. Alternatively, the transparent ink is printed on the anti-sublimation layer 9 by the silk-screening technology, then hot-melt powder is sprayed on the surface of the wet transparent ink, and the wet transparent ink is dried to form the hot-melt layer 7.

Other technical features are the same as those of Embodiment 1.

The electronic labels in Embodiment 1 to Embodiment 4 in the present invention all have a heat transfer function, and thus can be easily transferred to fabric. By the silk-screening technology, the ink or liquid glue needs to be printed after the ink or liquid glue in the previous step is completely dried to avoid ink delamination between the pattern layers 2 and delamination between the pattern layer 2 and other layers. The use of the multi-layer liquid glue significantly improves the bonding between two adjacent layers, whereby the chip 6 can be securely wrapped inside. The multi-layer ink and glue structure increase the overall elasticity of the label making the label difficult to be punctured by the chip and providing good protection to the chip. In use, the electronic heat transfer label and garment carrying the same can be washed many times without the occurrence of delamination. The built-in RFID or NFC chip 6 can be read and identified normally as well.

The labels prepared in Embodiment 1 to Embodiment 4 and the labels prepared in the prior art are tested by water washing. The specific test method includes: an electronic heat transfer label is transferred to fabric, and the fabric is placed and agitated in an agitator/drum-type washing machine at a water temperature of 41° C. for 90 min each time (the washing machine has a drying function and performs drying after each agitation, and continues to perform agitation after the drying; and such operations are repeatedly performed for 5 or 10 times). Then, information pre-stored in the chip in the label is read via a reading device to obtain the comparison results shown in the following Table.

| | | | Comparative | | |
|---|---|---|---|---|---|
| | | | Example 1 | Comparative | |
| | | | (differs from | Example 2 | |
| | | | Embodiment 1 | (differs from | |
| | | | only in that no | Embodiment | |
| | | Prior art | glue layer is | 1 only in that | |
| | | (made according to | printed on | no first glue | |
| | | the label structure of | both sides of | layer is | Embodiments |
| | | CN2014202398610) | the chip) | printed) | 1-4 |
| After | Appearance | Basically intact | Basically | Basically | Intact |
| washing | of the label | | intact | intact | |
| with | Whether the | Yes, (the pattern on | Yes, (the | Yes, (the | No |
| water | label is | the label surface has a | pattern on the | pattern on the | |
| for 5 | delaminated | certain bulge, and if | label surface | label surface | |
| times | | the label surface is | has a certain | has a certain | |
| | | gently torn off, one or | bulge, and if | bulge, and if | |
| | | more layers of the | the label | the label | |
| | | pattern layer will be | surface is | surface is | |
| | | torn apart) | gently torn | gently torn | |
| | | | off, one or | off, one or | |
| | | | more layers of | more layers of | |
| | | | the pattern | the pattern | |
| | | | layer will be | layer will be | |
| | | | torn apart) | torn apart) | |
| | Whether the | No | No | No | No |
| | chip is | | | | |
| | exposed | | | | |
| | Whether the | Some pre-stored data | Some pre- | Some pre- | Pre-stored |
| | chip data is | can be read, but not | stored data | stored data | data can be |
| | read | all data can be read. | can be read, | can be read, | read |
| | | | but not all | but not all | completely. |
| | | | data can be | data can be | |
| | | | read. | read. | |
| After | Appearance | Not intact | Not intact | Basically | Intact |
| washing | of the label | | | | intact |
| with | Whether the | Yes, (the pattern on | Yes, (the | Yes, (the | No |
| water | label is | the label surface has a | pattern on the | pattern on the | |
| for 10 | delaminated | large-area bulge, and | label surface | label surface | |
| times | | if the label surface is | has a large- | has a certain | |
| | | gently torn off, one or | area bulge, | bulge, and if | |
| | | more layers of the | and if the | the label | |
| | | pattern layer will be | label surface | surface is | |
| | | torn apart) | off, one or | gently torn | |
| | | | more layers of | is gently torn | |
| | | | the pattern | off, one or | |
| | | | layer will be | more layers of | |
| | | | torn apart) | the pattern | |
| | | | | layer will be | |
| | | | | torn apart) | |
| | Whether the | Partially exposed | Partially | No | No |
| | chip is | | exposed | | |
| | exposed | | | | |
| | Whether the | No | No | Some pre- | Pre-stored |
| | chip data is | | | stored data | data can be |
| | read | | | can be read, | read |
| | | | | but not all | completely. |
| | | | | data can be | |
| | | | | read. | |

As shown in the above Table, the labels obtained by the preparation methods of Embodiments 1 to 4 each have the following characteristics:

1) The label remains intact and the chip is not damaged and can be read, and the data can be read via a corresponding RFID reader or a mobile phone with an NFC function.

2) The label is not delaminated (no delamination means that the ink layer, the glue layer, the chip and other layers are well connected and not separated).

The above description is only the preferred embodiments of the present invention, but the scope of protection of the present invention is not limited to the foregoing embodiments. All technical solutions belonging to the concept of the present invention shall fall within the scope of protection of the present invention. It should be noted that those having ordinary skill in the art can make several improvements and modifications without departing from the principles of the present invention, and these improvements and modifications shall also fall within the scope of protection of the present invention.

What is claimed is:

1. An electronic heat transfer label, comprising
a substrate;
wherein
an ink is printed on the substrate to form a pattern layer, and an adhesive is printed on the pattern layer to form a first adhesive layer;
a chip is attached onto the first adhesive layer, and an adhesive is printed on the chip to form a second adhesive layer; and
the second adhesive layer covers the chip, and a hot-melt layer is arranged on the second adhesive layer.

2. The electronic heat transfer label according to claim 1, wherein, the pattern layer is one selected from the group consisting of a transparent image, a solid-colored image, a multi-colored image, and an image containing a scannable mark.

3. The electronic heat transfer label according to claim 1, wherein, the adhesive is glue.

4. The electronic heat transfer label according to claim 1, wherein a product is configured to receive the electronic heat transfer label.

5. The electronic heat transfer label according to claim 4, wherein, the chip is sensed via a mobile terminal to trigger the mobile terminal to be connected to an information database of the product, wherein the information database of the product corresponds to the electronic heat transfer label.

6. The electronic heat transfer label according to claim 1, wherein, the hot-melt layer comprises at least one layer of glue.

7. The electronic heat transfer label according to claim 6, wherein, a layer of glue of the at least one layer of the glue has a thickness of 0.01-0.04 mm after being dried.

8. The electronic heat transfer label according to claim 1, wherein, the hot-melt layer comprises at least one layer of a transparent ink and hot-melt powder, wherein the hot-melt powder is adhered onto the at least one layer of the transparent ink.

9. The electronic heat transfer label according to claim 1, wherein, a colored ink is printed on the second adhesive layer to form a shielding layer.

10. The electronic heat transfer label according to claim 1, wherein, an anti-sublimation ink is printed on the second adhesive layer to form an anti-sublimation layer.

11. The electronic heat transfer label according to claim 1, wherein, a white background layer is arranged between the pattern layer and the first adhesive layer.

12. The electronic heat transfer label according to claim 1 wherein, the pattern layer comprises at least three layers of the ink.

13. The electronic heat transfer label according to claim 11, wherein, the pattern layer and the white background layer comprise at least three layers of the ink in total.

14. The electronic heat transfer label according to claim 1, wherein, the chip is an RFID chip or an NFC chip.

15. A method for preparing an electronic heat transfer label, comprising the following steps:
S1: printing an ink on a substrate and drying the ink to form a pattern layer;
S2: printing at least one layer of a first adhesive on the pattern layer and drying the at least one layer of the first adhesive to form a first adhesive layer;
S3: attaching a chip onto the first adhesive layer;
S4: printing at least one layer of a second adhesive onto the first adhesive layer and the chip, and drying the at least one layer of the second adhesive to form a second adhesive layer; and
S5: printing at least one layer of glue on the second adhesive layer and drying the at least one layer of the glue to form a hot-melt layer; or printing a transparent ink on the second adhesive layer, then spraying hot-melt powder on a surface of the transparent ink, and drying the hot-melt powder and the transparent ink to form a hot-melt layer.

16. The method according to claim 15, wherein, after step S4 and before step S5, at least one layer of a colored ink is printed on the second adhesive layer and dried to form a shielding layer to protect the chip from exposure.

17. The method according to claim 15, wherein, after step S4 and before step S5, an anti-sublimation ink is printed on the second adhesive layer and dried to form an anti-sublimation layer.

18. The method according to claim 16, wherein, an anti-sublimation ink is printed on the shielding layer and dried to form an anti-sublimation layer.

19. The method according to claim 15, wherein, after the ink is printed to form the pattern layer in step S1, a white ink or a mixture of the white ink and a colored ink of the pattern layer is printed on the pattern layer and dried to form a white background layer.

20. The method according to claim 15, wherein, in step S1, after the ink is printed by a digital printer to form the pattern layer, a transparent ink is printed on the pattern layer by a screen printer and then the transparent ink is dried.
